(19) United States
(12) Patent Application Publication
(10) Pub. No.: US 2025/0135424 A1
(43) Pub. Date: May 1, 2025

(54) Integrated thermal energy storage for hydrocarbon pyrolysis

(71) Applicant: Molten Industries Inc., Oakland, CA (US)

(72) Inventors: Kevin A. Bush, Oakland, CA (US); Caleb C. Boyd, San Francisco, CA (US); Brandon J. Stitt, Alameda, CA (US); Robert G. Wendt, Gilroy, CA (US)

(21) Appl. No.: 18/928,147

(22) Filed: Oct. 27, 2024

Related U.S. Application Data
(60) Provisional application No. 63/546,168, filed on Oct. 27, 2023.

(51) Int. Cl. B01J 6/00; C01B 3/26; C01B 32/05

(52) U.S. Cl. CPC B01J 6/008; C01B 3/26; C01B 32/05; C01B 2203/0277; C01B 2203/0805; C01B 2203/1241

(57) ABSTRACT

A thermochemical system and method for thermochemical decomposition of a hydrocarbon feedstock such as methane or natural gas within an insulated volume where the important elements of the thermochemical system are located within the insulated volume. The insulated volume contains a heater and a thermal energy storage medium in thermal communication with the heater such that it is heated by the heater and stores the thermal energy it receives by a heat storage process. The thermal energy storage medium is also configured to release the thermal energy that it stored in the form of a released heat. The insulated volume also contains a hydrocarbon pyrolysis reactor thermally coupled with the thermal energy storage medium to receive the released heat and use it for driving pyrolysis of the hydrocarbon feedstock to produce pyrolysis products containing primarily hydrogen and a solid carbon product. Pyrolysis of the hydrocarbon feedstock is driven at a high temperature, such as between 700° C. and 2,000° C.

### CROSS-REFERENCE TO RELATED APPLICATIONS

This application claims priority from U.S. Provisional Patent Application No. 63/546,168 filed on Oct. 27, 2023 and which is incorporated herein by reference for all purposes in its entirety.

### FIELD OF THE INVENTION

The present invention relates to integration of thermal energy storage and the delivery of hydrogen via thermochemical decomposition or pyrolysis of a hydrocarbon feedstock such as methane, where the thermal energy storage is thermally coupled to and controls the operation of a hydrocarbon pyrolysis reactor in which the thermochemical decomposition is taking place.

### BACKGROUND OF THE INVENTION

The United States produces 10 million metric tons of hydrogen per year. 95% of it is produced via steam methane reforming (SMR) and is accompanied by the emission of 100 million tons of CO₂ in the process, as documented by A. Majumdar et al., “A framework for a hydrogen economy”, Joule, Vol. 4, Issue 8, 18 Aug. 2021, pp. 1905-1908.

Methane pyrolysis, also known as methane cracking or methane splitting, involves the thermochemical decomposition of a hydrocarbon feedstock primarily composed of methane (CH₄) into its constituent elements, namely hydrogen (H₂) and solid carbon. Note that other products of the hydrocarbon decomposition process may be formed such as ethane, ethylene, acetylene and benzene. The pyrolysis process is typically conducted at elevated temperatures, typically above 1,000° C., in the absence of oxygen to avoid the formation of gaseous carbon dioxide (CO₂) and carbon monoxide (CO). Furthermore, the pyrolysis process is endothermic and requires a substantial input of heat energy to break the carbon-hydrogen bonds in methane.

Methane pyrolysis is potentially the most cost-effective solution to reduce emissions associated with hydrogen production. Unfortunately, the existing approaches have proved difficult to scale. Scaling issues have been documented by M. Steinberg, “The direct use of natural gas for conversion of carbonaceous raw materials to fuels and chemical feedstocks”, International Journal of Hydrogen Energy, Vol. 11, Issue 11, 1986, pp. 715-720 and also by S. Schneider et al., “State of the Art of Hydrogen Production via Pyrolysis of Natural Gas, ChemBioEng Reviews, Vol. 7, 2020, pp. 1-10. Still, obtaining hydrogen via methane decomposition holds the promise of being less expensive than producing it through water electrolysis or through existing steam methane reforming with carbon capture.

Thermal or thermochemical decomposition of a hydrocarbon feedstock such as methane can be performed with or without the presence of an active catalyst. In the absence of a catalyst, temperatures for thermal decomposition of methane into hydrogen and solid carbon are typically above 1,000° C. Catalytic materials can reduce the temperature of thermal decomposition to as low as 400° C. or even lower. Catalytic materials for the decomposition of hydrocarbons include but are not limited to Group VIb and VIII elements of the periodic table such as iron (Fe), nickel (Ni), cobalt (Co), noble metals, chromium (Cr), molybdenum (Mb), alloys of these metals and even salts and oxides containing these metals.

With or without catalysts, scalable, cost-effective methane pyrolysis has yet to be widely commercialized as it presents a number of fundamental process design and scale-up challenges. The high temperature requirements constrain the choice of construction materials and require efficient heat transfer at high throughputs. The process generates both gaseous hydrogen and solid carbon, which must be physically separated. In fact, deposition of solid carbon in the reactor or coking is a major operational problem for thermal decomposition of any hydrocarbon feedstock. Further, the process requires frequent reactor cleaning. This results in downtime and non-continuous operation. Catalysts are deactivated by solid carbon deposition and must be replaced or cleaned. Catalytic metals and salts can contaminate the solid carbon byproduct such that it cannot be used in all applications. Indeed, in some cases the extent of contamination is so high that the solid carbon byproduct must even be disposed of as toxic waste.

Patents on the thermal decomposition of a hydrocarbon feedstock have been around for over a century. One of the first is U.S. Pat. No. 1,107,926 by Albert Rudolph Frank who observed the decomposition of methane at temperatures over 1,200° C. Auguste Jean Paris Jr. was the first to patent methane pyrolysis in molten media in 1915 in U.S. Pat. Nos. 1,756,877 and 1,392,788. Typical approaches to hydrocarbon decomposition include moving bed and fluidized bed reactors, plasma reactors, microwave reactors, molten bath reactors and fluid wall reactors. The primary challenge in the operation of a continuous or semi-continuous methane pyrolysis process lies in overcoming reactor fouling caused by the formation of solid carbon. Solid carbon can coat reactor surfaces. This is especially true in cases where the thermal decomposition occurs at a surface and leads to the formation of a hard carbon deposit thereon. The deposit can build up to the point where it could clog the reactor and thus force a shutdown and cleaning.

Plasma, microwave and fluidized bed reactors typically attempt to overcome the carbon fouling issue by ensuring that energy or heat is transferred to the methane away from the walls of the reactor, thus forming a carbon product that can be fluidized out of the reactor. The challenge with these reactors is that their walls typically need to be cooled to avoid carbon deposition on them, thus lowering the energy efficiency of the reactor.

The source of heat is important in the design of a methane pyrolysis reactor, especially when a primary goal is the production of clean hydrogen. Here, clean hydrogen is defined as hydrogen that was produced with minimal carbon dioxide (CO₂) emissions. In order to minimize CO₂ emissions, it is preferable to utilize renewable energy sources such as geothermal, wind, solar thermal, solar photovoltaics, or nuclear energy to input heat to drive the endothermic hydrocarbon pyrolysis process forward. Methane pyrolysis has the potential to use up to seven times less energy than water electrolysis.

Unfortunately, low-cost sources of renewable energy are often intermittent. Their intermittent nature arises from the natural phenomena they utilize. Thus, solar photovoltaics produce their peak power output when in full sunlight, wind turbines produce their peak power output when the wind is blowing, hydro-electric produces largely continuous electricity but the actual power output is largely seasonal, and tidal power output depends on the tides.

The challenge with the use of intermittent renewables is that it is preferable to operate high temperature processes such as hydrocarbon pyrolysis continuously and hydrocarbon pyrolysis is an endothermic process such that additional energy needs to be added to drive the reaction forward. Additionally, for many industrial applications of hydrogen such as iron ore reduction or chemical production, it is preferable to have access to a continuous supply of hydrogen. This could be accomplished by storing the hydrogen in storage vessels, but the storage of hydrogen is difficult due to the low density of hydrogen gas.

Thus, challenges remain in overcoming the intermittent nature of desirable energy sources while providing for continuous delivery of hydrogen via hydrocarbon pyrolysis for use in industrial applications and still managing to use intermittent energy sources to drive the pyrolysis reaction.

### Objects and Advantages

The present invention is aimed at overcoming the challenges by producing and delivering hydrogen continuously via hydrocarbon pyrolysis for use in industrial applications while relying on intermittent energy sources to drive the pyrolysis reaction.

More specifically, it is an aim of the present invention to enable the delivery of pyrolysis products that include hydrogen and solid carbon from the pyrolysis of a hydrocarbon feedstock such as methane, while overcoming the challenges associated with requiring the same temporal profile for heat input and pyrolysis outputs.

### SUMMARY OF THE INVENTION

The objects and advantages of the invention are provided for by a thermochemical system and method for thermochemical decomposition of a hydrocarbon feedstock such as methane or natural gas. Thermochemical decomposition of such hydrocarbon feedstock is also known as pyrolyzation, cracking or direct decomposition.

The thermochemical system has an insulated volume that is enclosed by an insulation material to reduce heat loss from the insulated volume to the surrounding environment. Important elements belonging to the thermochemical system are located within the insulated volume. Specifically, a heater is located inside the insulated volume. A thermal energy storage medium contained by a containment material is also located inside the insulated volume. The containment material is preferably selected from among refractory materials based on alumina (Al₂O₃), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, calcium oxide (CaO) and carbon.

In accordance with the invention, the thermal energy storage medium is positioned in such a way that it is in thermal communication with the heater. Thus, the thermal energy storage medium is subject to heating by the heater and storing the thermal energy it receives from the heater by a heat storage process. The thermal energy storage medium is also configured for releasing the thermal energy that it stored in the form of a released heat.

The insulated volume further contains a hydrocarbon pyrolysis reactor. The hydrocarbon pyrolysis reactor is thermally coupled with the thermal energy storage medium for receiving the released heat from the thermal energy storage medium. In accordance with the invention, the hydrocarbon pyrolysis reactor uses the released heat for performing thermochemical decomposition through pyrolysis of the hydrocarbon feedstock to produce pyrolysis products that primarily contain hydrogen and a solid carbon product. In fact, the solid carbon product can be solid carbon.

Pyrolysis of the hydrocarbon feedstock is preferably performed at high temperature. Preferably, the pyrolyzation temperature is between 700° C. and 2,000° C. It is further preferred that a fraction of the solid carbon product be fluidized out of the hydrocarbon pyrolysis reactor by the pyrolysis products. Operating at high temperature is conducive to fluidizing solid carbon out of the hydrocarbon pyrolysis reactor. Further, it is preferable that when using methane as the hydrocarbon feedstock the hydrocarbon pyrolysis reactor be set to maintain a methane to hydrogen reaction yield of greater than 70%.

The heating of the thermal energy storage medium takes place over a certain period of time. It is advantageous when a timing or temporal profile of the heating is independent of or decoupled from the receiving of the released heat by the hydrocarbon pyrolysis reactor and hence decoupled from the thermochemical decomposition of the hydrocarbon feedstock through pyrolysis. This is particularly important when the energy input into the heater is discontinuous, periodic or intermittent. Such cases arise when the energy input is provided by an intermittent energy source that can be selected from among wind turbines, solar photovoltaics, solar thermal generators, tidal energy generators and hydro-electric energy generators.

The heat storage process can take advantage of different thermodynamic heat storage capacities of the thermal energy storage medium. The heat storage process can take advantage of a latent heat energy storage process which is a constant-temperature process such as a first-order phase transition and specifically a solid to liquid phase transition of the thermal energy storage medium. Correspondingly, the released heat is generated at constant temperature as the thermal energy storage medium undergoes a liquid to solid phase transition. When relying on a latent heat energy storage process the thermal energy storage medium is selected from materials such as silicon (Si), germanium (Ge), iron (Fe), steel, manganese (Mn), cobalt (Co), chromium (Cr), nickel (Ni), silver (Ag), Copper (Cu), titanium (Ti), Calcium (Ca), Fe/Si alloys, Fe/Ti alloys, iron silicates, cast iron, iron oxide (FeO), copper oxide (CuO), sodium metasilicate (Na₂SiO₃), sodium fluoride (NaF), potassium fluoride (KF), lithium fluoride (LiF), calcium fluoride (CaF₂), thorium fluoride (ThF₄), potassium carbonate (K₂CO₃), lead oxide (PbO), sodium carbonate (Na₂(CO₂)₃), sodium chloride (NaCl), calcium chloride (CaCl₂), potassium chloride (KCl), barium chloride (BaCl₂), nickel chloride (NiCl₂), magnesium chloride (MgCl₂), calcium bromide (CaBr₂), potassium iodide (KI) or a mixture of these materials. One skilled in the art will recognize that any material with a phase transition between the desired temperature range for pyrolysis of preferably 700° C. to 2,000° C. can be used as a suitable thermal energy storage medium for the present invention. Note, latent heat is also released in a gas to liquid phase transition, but liquid to solid phase transition is of primary consideration due to the higher densities of these phases, leading to correspondingly higher energy density.

The containment material that supports such thermal energy storage medium is then located in a suitable environment such as an inert environment, a reducing environment, an oxidizing environment or a vacuum environment. It is preferred in the case of an oxidizing thermal energy storage environment that the hydrocarbon pyrolysis reactor is contained in a hydrocarbon reaction vessel and the containment material that contains the thermal energy storage medium is in contact with the hydrocarbon reaction vessel.

The heat storage process can also take advantage of a sensible energy storage process which is based on an increase in temperature of the thermal energy storage medium. The increase in temperature can take place while the thermal energy storage medium is in a solid phase or in a liquid phase. Correspondingly, the released heat is generated with a decrease in temperature of the thermal energy storage medium. When relying on a sensible energy storage process the thermal energy storage medium is selected from materials including all of the latent heat materials named above and others such as molten salts, carbon, graphite, silica, alumina, magnesia and mixtures of these materials. Further, the thermal energy storage medium is contained in an environment that is either an inert environment, a reducing environment or a vacuum environment. More specifically still, the thermal energy storage medium can be a material selected from among aluminum oxide (Al₂O₃), silicon dioxide (SiO₂), calcium fluoride (CaF₂), sodium metasilicate (Na₂SiO₃), nickel chloride (NiCl₂), sodium fluoride (NaF), copper oxide (Cu₂O), iron oxide (FeO) or a mixture of these materials and is contained in an oxidizing environment. Here, it is also preferred that the hydrocarbon pyrolysis reactor be contained in a hydrocarbon reaction vessel that is in physical proximity to the thermal energy storage medium. The physical proximity can be ensured by positioning the hydrocarbon pyrolysis reactor on top of the thermal energy storage medium or else beside or underneath the thermal energy storage medium. One skilled in the art will recognize that there are almost infinite potential materials and combinations of materials that can be used to store sensible heat, and preferable materials will be chosen based on availability, cost, and the ability to withstand temperature of at least 700° C. and up to as high as 3,000° C.

In many embodiments the thermal energy storage medium is a molten metal or salt. The hydrocarbon pyrolysis reactor is then thermally coupled with the thermal energy storage medium via injection of the hydrocarbon feedstock into the thermal energy storage medium. Such thermal coupling provides for transferring the released heat through contact between the molten metal or salt and the hydrocarbon feedstock. Thus, the sensible energy storage process is based on an increase in temperature of the molten metal or salt into which the hydrocarbon stock is being injected. The reaction temperature at which the pyrolysis of the hydrocarbon feedstock is performed is then varied in accordance with the temperature of the molten metal or salt. In fact, in some embodiments the hydrocarbon pyrolysis reactor can be located within the molten metal or salt that serves as the thermal energy storage medium.

The thermal coupling between the hydrocarbon pyrolysis reactor and the thermal energy storage medium can support different thermal or heat transfer mechanisms. In particular, the released heat that is discharged into the hydrocarbon pyrolysis reactor can be thermally coupled through at least one heat transfer mechanism that includes radiation, convection and conduction. In some cases, the thermal energy storage medium is positioned proximate to the hydrocarbon pyrolysis reactor in such a manner that the thermal coupling supports heat transfer by radiation between the thermal energy storage medium and the hydrocarbon pyrolysis reactor.

In some cases where the hydrocarbon pyrolysis reactor is contained in the hydrocarbon reaction vessel. The hydrocarbon reaction vessel can be positioned above the thermal energy storage medium and thus the heat transfer is driven by convective currents due to a temperature gradient between the hydrocarbon reaction vessel and the thermal energy storage medium. Of course, this heat transfer includes the transfer of the released heat. In other cases, the hydrocarbon reaction vessel is thermally coupled with the thermal energy storage medium by a heat transfer fluid. Suitable heat transfer fluid can be a liquid or a gas that can be circulated between the thermal energy storage medium and the pyrolysis reaction vessel to drive heat transfer including transfer of the released heat. A mechanism for adjusting the flow rate of the heat transfer fluid is also provided in some embodiments. In still other cases, the hydrocarbon reaction vessel is thermally coupled with the thermal energy storage medium with a mechanism for adjusting an area receiving a radiative heat flux from the thermal energy storage medium including the released heat. The mechanism can be selected from among shutters, apertures and lenses.

When the heat storage process involves sensible energy storage based on an increase in temperature of the thermal storage medium the pyrolysis of the hydrocarbon feedstock is performed at a reaction temperature varied between 800° C. and up to 2,000° C. Pyrolysis at such temperatures can be catalyzed or uncatalyzed.

The invention can be practiced with many types of heaters. In some cases, the heater is heated by electrical energy. In other cases, the heater is heated by chemical energy of combustion supplied by the heater. In still other cases thermal coupling between the thermal energy storage medium and the hydrocarbon pyrolysis reactor is achieved by virtue of the latter including or containing the thermal energy storage medium.

The thermochemical system is advantageous in situations where energy supply to the heater is not continuous and may be unavailable for long periods of time. In such situations the thermal energy storage medium is configured to release the released heat in a quantity that is sufficient to maintain thermochemical decomposition of the hydrocarbon feedstock for a considerable time period. This time period can be greater than 1 hour, and under some circumstances greater than 4 hours or even greater than 12 hours.

The invention further extends to a thermochemical decomposition of hydrocarbon feedstock through pyrolysis in relying on the thermal energy storage medium. The method relies on latent and sensible heat storage processes to drive the pyrolysis reaction.

The present invention, including the preferred embodiment, will now be described in detail in the below detailed description with reference to the attached drawing figures.

### BRIEF DESCRIPTION OF THE DRAWING FIGURES

FIG. 1A is a three-dimensional schematic diagram of a thermochemical system according to the invention

FIG. 1B is a plan schematic view illustrating in more detail thermal communication during a charging or heating period of thermal energy storage medium belonging to the thermochemical system of FIG. 1A

FIG. 1C is a plan schematic view illustrating in more detail thermal coupling during a discharging or cooling period of thermal energy storage medium belonging to the thermochemical system of FIG. 1A

FIG. 2A is a schematic graph that shows the charging or heating of thermal energy storage medium in the configuration shown in FIG. 1B

FIG. 2B is a schematic graph that shows the discharging or cooling of thermal energy storage medium in the configuration shown in FIG. 1C

FIG. 3 is a flow diagram illustrating the steps involved in the setup of the thermochemical system of FIG. 1A and of alternative thermochemical systems

FIG. 4 is a flow diagram illustrating the steps involved in the operation of the thermochemical system of FIG. 1A and of alternative thermochemical systems

FIG. 5 is a plan schematic view of a thermochemical system according to the invention that uses a reaction vessel to contain the insulated volume

FIG. 6 is a plan schematic view another thermochemical system according to the invention that uses a reaction vessel

FIG. 7 is a plan schematic view yet another thermochemical system according to the invention that uses a reaction vessel

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

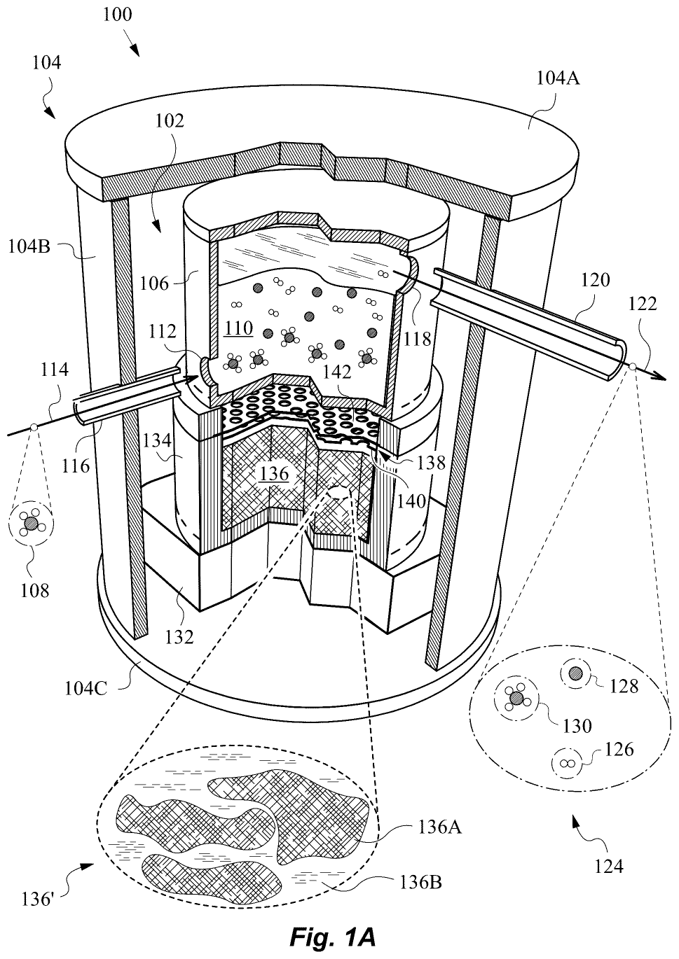

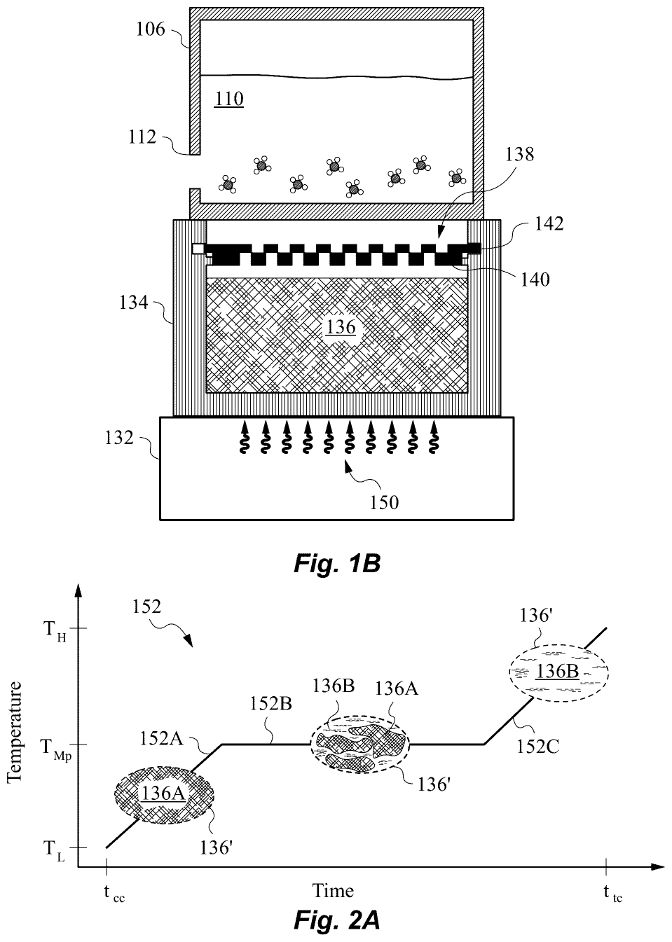

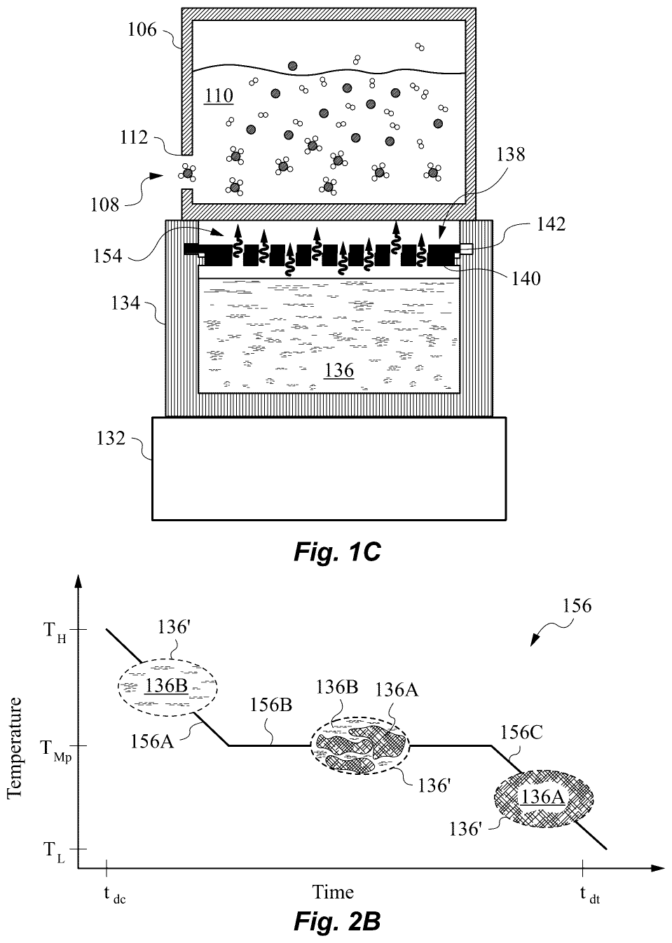

FIG. 1A is a three-dimensional schematic diagram of a thermochemical system 100 with an insulated zone or insulated volume 102 according to the invention. FIG. 1A has several cut-away portions and partial sections in order to better illustrate the interior of insulated volume 102 with the elements located in it and their interiors as well.

Insulated volume 102 is established within or enclosed by an insulation container 104 that has a top cover 104A, side wall 104B and a bottom plate 104C. Top cover 104A, side wall 104B and bottom plate 104C are made of an insulation material designed to reduce heat loss from insulated volume 102 to the surrounding environment. Limiting heat loss is important for proper operation of thermochemical system 100 and hence the key parts or elements of thermochemical system 100 are located within insulated volume 102.

Top cover 104A, side wall 104B and bottom plate 104C of insulation container 104 can all have different thicknesses ranging from a few centimeters to a few meters according to the material chosen and level of heat loss reduction required. The choice of materials for insulation container 104 includes refractory ceramic insulation based on alumina (Al₂O₃), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, Calcium oxide (CaO), graphite, other carbon-based insulating materials and mixtures of those materials or mixtures of insulation of different material types. Good insulation material for insulation container 104 is typically characterized by low density. In some cases, the material can include powders with low density or low packing density such as thermal insulation.

Insulated volume 102 contains a hydrocarbon pyrolysis reactor 106 for performing thermochemical decomposition of a hydrocarbon feedstock 108 through pyrolysis. In the present embodiment, hydrocarbon feedstock is methane 108 (CH₄). Methane 108 is visualized in highly magnified molecular form within a dashed and dotted outline. It should be noted, however, that thermochemical system 100 can use various types of hydrocarbon feedstock 108 including gasses, liquids, or solids containing one or more hydrocarbons such as methane, butane, propane, ethane, ethylene, acetylene, propylene, natural gas, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons. Mixtures of any of the above feedstocks with other hydrocarbon feedstocks can be used, as well as mixtures containing any of these feedstocks with other feedstocks such as mixtures of methane and nitrogen, methane and carbon dioxide, or methane and carbon monoxide. A preferred embodiment uses natural gas or a hydrocarbon feedstock primarily composed of methane (CH₄) as in the present embodiment.

Many specific types of pyrolysis reactors can be used in thermochemical system 100. For example, hydrocarbon pyrolysis reactor 106 can be a thermal pyrolysis reactor, a microwave pyrolysis reactor, a plasma pyrolysis reactor, a liquid salt or metal containing pyrolysis reactor, a liquid salt containing pyrolysis reactor and a catalytic pyrolysis reactor. Preferably, hydrocarbon pyrolysis reactor 106 is a thermal, liquid salt or metal containing pyrolysis reactor where hydrocarbon feedstock 108 is thermally decomposed within a molten salt or metal 110. In some cases, pyrolysis reactor 106 can include purifying systems, separation systems, or gasification systems before its thermal decomposition stage to purify hydrocarbon feedstock 108 for decomposition and after the thermal decomposition reactor 106 to separate out and purify products of thermal decomposition. A typical example for a pre-treatment is desulfurization of natural gas.

Hydrocarbon pyrolysis reactor 106 has an inlet 112 for admitting an inflow 114 of hydrocarbon feedstock 108. Inflow 112 is delivered through a delivery pipe 116 (partially shown) that passes through side wall 104B of insulation container 104 and to inlet 112 of hydrocarbon pyrolysis reactor 106. Further, pyrolysis reactor 106 has a top outlet 118 with an outlet pipe 120 (partially shown) for releasing a flow 122 of pyrolysis products 124. Pyrolysis products 124 are shown in an enlarged view within a dashed and dotted outline in FIG. 1A.

Pyrolysis products 124 in flow 122 include hydrogen 126 and a pyrolysis-derived solid carbon product 128. In fact, pyrolysis reactor 106 should be set up to decompose hydrocarbon feedstock 108 into primarily solid carbon product 128 and hydrogen 126. Nevertheless, pyrolysis reactor 106 typically also releases a hydrocarbon fraction 130. Hydrocarbon fraction 130 is principally composed of unreacted hydrocarbon feedstock 108, in this case methane (CH₄). Hence, it is also visualized in FIG. 1A as methane in highly magnified molecular form within a dashed and dotted outline along with the other components of pyrolysis products 124. More generally, however, hydrocarbon fraction 130 consists of a variety of hydrocarbons such as methane, ethane, ethylene, acetylene, and aromatic hydrocarbons. Furthermore, it should be noted that a certain amount of hydrocarbon fraction 130 being part of pyrolysis products 124 is actually desirable for some downstream applications, as will be appreciated by those skilled in the art.

Insulated volume 102 further contains a heater 132 located on bottom plate 104C of insulation container 104. Heater 132 can be an electrical heater or a heater that uses the chemical energy of combustion for heating. Heater 132 can use resistive heating elements made of materials such as silicon carbide, molybdenum disilicide, nichrome, graphite, carbon fiber composite, tungsten, tantalum or iron-chromium-aluminum alloys. Heater 132 can also be an induction heater that uses a high-frequency alternating current (AC) power source (not shown) to generate an alternating magnetic field within a coil or induction heating coil.

In accordance with the invention, a containment material 134 that holds a thermal energy storage medium 136 is located within insulation container 104 that defines insulated volume 102. In the present embodiment, containment material 134 is in the form of a vessel that holds within it thermal energy storage medium 136. Containment material 134 is preferably selected from among high temperature materials including nickel-based alloys, refractory metals, and refractory materials based on alumina (Al₂O₃), zirconia (ZrO₂), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, calcium oxide (CaO) and carbon such as graphite.

The vessel of containment material 134 holds thermal energy storage medium 136 immediately above heater 132 to ensure that the former is in thermal communication with heater 132. Thus, thermal energy storage medium 136 is subject to heating by heater 132. An enlarged portion 136′ of thermal energy storage medium 136 being heated by heater 132 is shown in FIG. 1A within a dashed outline. The magnified view in enlarged portion 136′ shows that thermal energy storage medium 136 has domains or regions that are in solid phase 136A and also domains or regions that are in liquid phase 136B. In other words, at the time shown in FIG. 1A thermal energy storage medium 136 is experiencing a first-order phase transition between solid phase 136A and liquid phase 136B due to heating by heater 132.

Furthermore, vessel of containment material 134 holding thermal energy storage medium 136 is located below hydrocarbon pyrolysis reactor 106. Positioning pyrolysis reactor 106 above or on top of thermal energy storage medium 136 ensures that the former can be thermally coupled with thermal energy storage medium 136 when desired.

In the present case, thermal coupling between thermal energy storage medium 136 and hydrocarbon pyrolysis reactor 106 is mechanically controlled with the aid of a shutter mechanism 138. Shutter mechanism 138 consists of a bottom shutter plate 140 and a top shutter plate 142. Both bottom and top shutter plates 140, 142 have apertures that can be aligned with each other by moving top shutter plate 142 with respect to bottom shutter plate 140. Aligning the apertures opens shutter mechanism 138 while moving them out of alignment closes shutter mechanism 138. The material of bottom and top shutter plates 140, 142 must be able to withstand the high temperatures within insulated volume 102 between thermal energy storage medium 136 and hydrocarbon pyrolysis reactor 106. A good choice for this material includes high temperature materials including nickel-based alloys, refractory metals, and refractory metals based on alumina (Al₂O₃), zirconia (ZrO₂), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, calcium oxide (CaO) and carbon such as graphite.

FIG. 1B is a plan schematic view illustrating in more detail thermal communication between thermal energy storage medium 136 and heater 132 as well as thermal coupling between thermal energy storage medium 136 and hydrocarbon pyrolysis reactor 106. More precisely, FIG. 1B illustrates a charging or heating period during which a thermal energy 150 being delivered by heater 132 is being stored by thermal energy storage medium 136. During this charging or heating period thermal coupling between thermal energy storage medium 136 and hydrocarbon pyrolysis reactor 106 is prevented by virtue of shutter mechanism 138 being closed. In other words, the apertures of bottom and top shutter plates 140, 142 are fully misaligned thus thermally blocking thermal energy storage medium 136 from hydrocarbon pyrolysis reactor 106.

FIG. 2A is a schematic graph 152 that shows the heating of thermal energy storage medium 136 in the configuration shown in FIG. 1B. Heating occurs due to absorption of thermal energy 150 during the charging or heating period of thermal energy storage medium 136. Graph 152 incorporates magnified views of enlarged portion 136′ of thermal energy storage medium 136 to illustrate the nature of the heat storage processes relied upon in the present invention. Specifically, thermal energy storage or heat storage processes refer herein to the storage of energy as heat by inputting energy into thermal energy storage medium 136 preferably in solid or liquid phase. There are three primary heat storage processes at work: (1) sensible heat storage, (2) latent heat storage, and (3) thermochemical storage.

A first portion 152A of graph 152 illustrates the sensible heat storage process (1) that starts at a charge commence time tₒₒ once thermal energy 150 is being delivered to thermal energy storage medium 136. At charge commence time tₒₒ thermal energy storage medium 136 is at a low temperature T_{L}. Its enlarged portion 136′ shows that only solid phase 136A is present. During the sensible heat storage process thermal energy 150 delivered to thermal energy storage medium 136 causes a change in temperature without causing a change in phase. In other words, during the sensible heat storage process thermal energy storage medium 136 remains in solid phase 136A while its temperature rises from low temperature T_{L}.

Sensible heat is a form of thermal energy that can be sensed or measured using a thermometer. The amount of sensible heat required to change the temperature of thermal energy storage medium 136 depends on its mass m and specific heat capacity c. Specific heat capacity c is a measure of how much heat energy is required to raise the temperature of thermal energy storage medium 136 by one degree Celsius. Eq. 1 describes the sensible heat storage process where Qₛ is the sensible heat, m is mass, c is the specific heat capacity, and ΔT is the difference in temperature:

$${Q}_{s} = m \times c \times Δ T \qquad Eq . 1$$

Different substances have different specific heat capacities. This affects how much sensible heat is required to change their temperature. Therefore, the choice of material for thermal energy storage medium 136 is important, as discussed in detail below.

A second portion 152B of graph 152 illustrates the latent heat storage process (2). Latent heat refers to the heat that is absorbed or released by a substance during a process that causes a change in its phase such as melting, boiling or condensing. Unlike sensible heat, which changes the temperature of a substance, latent heat is associated with changes in the internal energy of a substance that are not accompanied by temperature changes. During a phase change, the energy that is absorbed or released is used to either break or form intermolecular bonds between the molecules of the substance.

In the case of thermal energy storage medium 136 the phase transition involves change from solid phase 136A to liquid phase 136B, as indicated in enlarged portion 136′ of medium 136 associated with second portion 152B of graph 152. The temperature at which this phase change occurs is the melting point temperature T_{Mp} of thermal energy storage medium 136. As evident from second portion 152B of graph 152, which has zero slope, thermal energy storage medium 136 remains at melting point temperature T_{Mp}, until all solid phase 136A melts or transitions to liquid phase 136B.

The amount of latent heat that is absorbed or released during a phase change depends on the specific latent heat of formation of the substance that thermal energy storage medium 136 is made of. It also depends on the amount of thermal energy storage medium 136 available or present in the vessel of containment material 134. Now, the specific latent heat is a measure of the amount of heat energy required to change the phase of one unit of mass of thermal energy storage medium 136 without changing its temperature and is typically measured in units of Joules per kilogram (J/kg). Eq. 2 describes latent heat energy Q_{L} where L is the specific latent heat of thermal energy storage medium 136 and m is its mass:

$${Q}_{L} = L \times m \qquad Eq . 2$$

Given Eq. 2 the choice of material and specific latent heat L of thermal energy storage medium 136 is important, as discussed in detail below.

A third portion 152C of graph 152 once again illustrates the sensible heat storage process (1) after thermal energy storage medium 136 has completed its phase transition. In other words, only liquid phase 136B is present, as indicated in enlarged portion 136′ associated with third portion 152C of graph 152. During the sensible heat storage process in liquid phase 136B thermal energy 150 delivered to thermal energy storage medium 136 causes a change in its temperature. In particular, its temperature rises from melting point temperature T_{Mp} to a final high temperature T_{H}. The delivery of thermal energy 150 stops at a charge termination time t_{tc} once high temperature T_{H} is reached. For this portion of the charging process Eq. 1 holds, but it should be noted that the value of heat capacity c in liquid phase 136B will differ from the value of c in solid phase 136A.

Although not shown in FIG. 2A, heat storage through a thermochemical storage process (3) can also be used by thermal energy storage medium 136 given a certain choice of material. Thermochemical energy storage is a process of storing thermal energy 150 by using chemical reactions that absorb or release heat. The process involves converting thermal energy 150 into chemical energy, which can then be stored in the form of a chemical compound by thermal energy storage medium 136. When energy is needed, the stored chemical energy is released, and the heat is recovered. Thermochemical energy storage typically involves a reversible chemical reaction that absorbs heat in an endothermic reaction and releases heat in an exothermic reaction. For example, the reaction between calcium oxide (CaO) and water (H₂O) is exothermic, releasing heat when they react to form calcium hydroxide (Ca(OH)₂). When the reverse reaction takes place, calcium hydroxide is dehydrated to produce calcium oxide and water, which is an endothermic reaction that absorbs heat.

FIG. 1C is a plan schematic view illustrating in more detail the thermal coupling between thermal energy storage medium 136 and hydrocarbon pyrolysis reactor 106. During this time period, heater 132 is turned off and thus there is no further thermal energy storage taking place in thermal energy storage medium 136. Instead, shutter mechanism 138 is open such that the apertures of bottom and top shutter plates 140, 142 are fully aligned thus permitting thermal energy 154 from thermal energy storage medium 136 to couple to hydrocarbon pyrolysis reactor 106. In other words, FIG. 1C illustrates a discharging period during which thermal energy 154 is being delivered from thermal energy storage medium 136 to hydrocarbon pyrolysis reactor 106.

FIG. 2B is a schematic graph 156 that shows the delivery of released heat 154 from thermal energy storage medium 136 in the configuration shown in FIG. 1C. Heating of hydrocarbon pyrolysis reactor 106, and more precisely of molten salt or metal 110 in which pyrolysis of hydrocarbon feedstock 108 occurs, is due to released heat 154 delivered during the discharging or cooling period of thermal energy storage medium 136. Graph 156 incorporates magnified views of enlarged portion 136′ of thermal energy storage medium 136 to illustrate the nature of the heat release processes relied upon in the present invention. Specifically, heat release processes refer herein to the release of thermal energy stored in any of the three primary heat storage processes discussed above.

A first portion 156A of graph 156 illustrates a time period during which released heat 154 originates from thermal energy previously stored in thermal energy storage medium 136 by the sensible heat storage process (1). Released heat 154 starts being delivered to thermal energy storage medium 136 at a discharge commence time t_{dc} when shutter mechanism 138 is opened. At discharge commence time t_{dc} thermal energy storage medium 136 is at high temperature T_{H}. Its enlarged portion 136′ associated with first portion 156A of graph 156 shows that only liquid phase 136B is present at this time. While released heat 154 is delivering energy previously stored by the sensible heat storage process thermal energy storage medium 136 experiences a change in temperature without a change in phase. In other words, during this period thermal energy storage medium 136 remains in liquid phase 136B while its temperature falls from high temperature T_{H}.

A second portion 156B of graph 156 illustrates a time period during which released heat 154 originates from thermal energy previously stored in thermal energy storage medium 136 by the latent heat storage process (2). Released heat 154 originating from the thermal energy stored in the phase transition is released while thermal energy storage medium 136 remains at melting point temperature T_{Mp}. During this time, thermal energy storage medium 136 undergoes the reverse of the phase transition it experienced during charging. In other words, thermal energy storage medium 136 changes from liquid phase 136B to solid phase 136A, as indicated in enlarged portion 136′ of medium 136 associated with second portion 156B of graph 156. Again, as evidenced by the fact that second portion 156B of graph 156 has zero slope, thermal energy storage medium 136 remains at melting point temperature T_{Mp} until all liquid phase 136B solidifies or transitions to solid phase 136A.

A third portion 156C of graph 156 illustrates a time period during which released heat 154 again originates from thermal energy previously stored in thermal energy storage medium 136 by the sensible heat storage process (1). During this time thermal energy storage medium 136 remains in solid phase 136A, as shown in enlarged portion 136′ associated with third portion 156C of graph 156, while its temperature drops from melting point temperature T_{Mp} to low temperature T_{L}. According to graph 156 low temperature T_{L} is reached at a discharge termination time t_{dt}. At discharge termination time t_{dt} thermal energy storage medium 136 is completely discharged and no further released heat 154 is delivered to hydrocarbon pyrolysis reactor 106 through shutter mechanism 138.

The thermal charging and discharging process, or a subset of the process, forms a cycle. Preferably, a cycle would charge with thermal energy 150 and discharge released heat 154 while maintaining thermal energy storage medium 136 at the constant temperature as shown in second portion 156B of graph 156. This charge and discharge cycle can be performed on thermal energy storage medium 136 as often as necessary to support pyrolysis of hydrocarbon feedstock 108 in hydrocarbon pyrolysis reactor 106. However, regardless of heat storage processes deployed by thermal energy storage medium 136 it is important that thermal energy storage medium 136 be well insulated to not lose too much heat to the surrounding environment between storing and releasing or delivering heat. The thermal insulation of thermal energy storage medium 136 by the vessel of containment material 134 at high temperatures can be very expensive and thus, in the present invention thermal energy storage medium 136 and hydrocarbon pyrolysis reactor 106 are integrated in insulated volume 102. Integrating pyrolysis reactor 106 and thermal energy storage medium 136 in the same insulated zone or insulated volume 102 has the benefits of decreasing insulation cost, heating component cost, reaction chamber costs, and balance of plant costs.

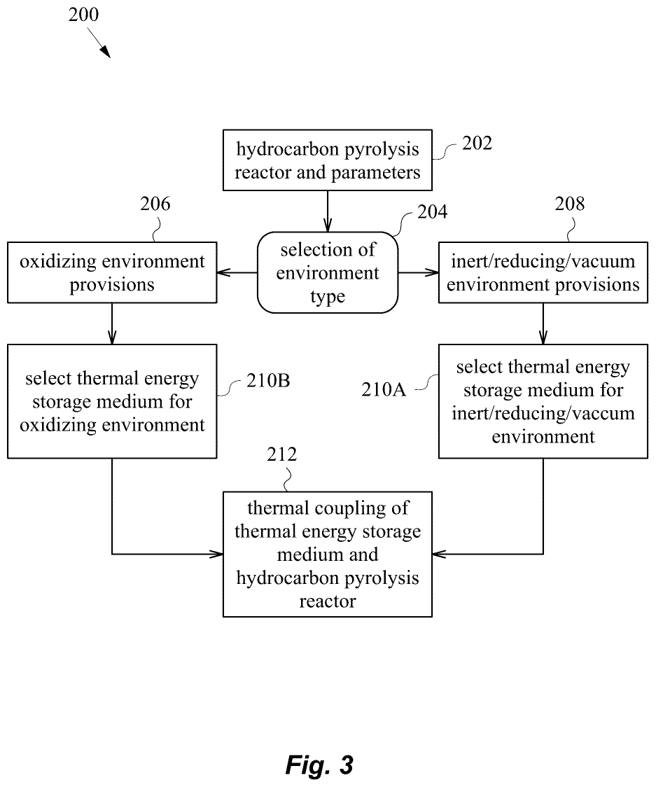

FIG. 3 is a setup flow diagram 200 that illustrates the details of setting up thermochemical system 100 with reference to elements illustrated in FIGS. 1A-C and the graphs shown in FIGS. 2A-B. The details of the setup include considerations in selecting appropriate thermal energy storage medium 136 given the requirements placed on hydrocarbon pyrolysis reactor 106, the pyrolysis reaction and other operating parameters.

In a first step 202 the parameters of pyrolysis dictated by type of hydrocarbon pyrolysis reactor 106 are established. These include the range of pyrolysis temperatures desired inside hydrocarbon pyrolysis reactor 106, hydrocarbon feedstock 108 being used and whether pyrolysis is catalyzed or uncatalyzed.

In the present exemplary embodiment hydrocarbon pyrolysis reactor 106 is a pyrolysis reactor that is thermal and contains liquid salt or metal 110. Hydrocarbon feedstock 108 is methane or natural gas. Pyrolysis of hydrocarbon feedstock 108 in liquid salt or metal 110 is performed at a pyrolyzation temperatures between 700° C. and 2,000° C. In addition, thermochemical decomposition of hydrocarbon feedstock 108 through pyrolysis is performed in the absence of oxygen or not in an oxidizing environment in order to avoid combustion. In other words, pyrolysis must occur in a reducing, vacuum, or inert environment.

Step 204 involves selection of the type of environment within insulated zone or insulated volume 102 given the above requirements. There is a fundamental distinction between materials that can be used as thermal energy storage medium 136 that can operate in inert and reducing environments (non-oxidizing) or in vacuum as opposed to materials that can operate in oxidizing environments that are to be avoided in hydrocarbon pyrolysis reactor 106.

Step 206 holds for cases where the material chosen for thermal energy storage medium 136 supports an oxidizing environment. In these cases, insulated volume 102 has to provide for a separation between thermal energy storage medium 136 and hydrocarbon pyrolysis reactor 106. Specifically, while both are kept inside insulated volume 102, the gas environment of thermal energy storage medium 136 has to be separated from the gas environment of hydrocarbon pyrolysis reactor 106. This is accomplished by placing hydrocarbon pyrolysis reactor 106 inside a hydrocarbon reaction vessel within which the gas environment can be kept inert or non-oxidizing.

Step 208 holds for cases where the material chosen for thermal energy storage medium 136 is also sensitive to oxidizing environments. This is preferred and is also the case in the present exemplary embodiment. Thus, insulated volume 102 maintains within it a gas environment that is either inert or reducing, or else it is pumped down to provide a vacuum environment.

Step 210A involves choosing the material for thermal energy storage medium 136 that is incompatible with an oxidizing environment and requires an inert, reducing or vacuum environment. In the present exemplary embodiment thermal energy storage medium 136 is a material which undergoes a phase transition between solid phase 136A and liquid phase 136B at a melting point temperature T_{Mp} in the range from 700° C. to 2,500° C. This enables thermal energy storage medium 136 to store thermal energy 150 and release latent heat energy Q_{L} in the form of released heat 154 at temperatures that are well matched with the pyrolyzation temperatures (700° C. to 2,000° C.). Thus, such choice of material allows energy storage medium 136 to drive the pyrolysis of hydrocarbon feedstock 108 inside hydrocarbon pyrolysis reactor 106.

There are several factors to be taken into consideration in the particular choice of material. These include material cost, required containment material 134, actual melting point temperature T_{Mp}, and boiling point temperature. There are materials which undergo a phase transition between solid phase 136A and liquid phase 136B in the temperature range of 800° C. to 1,900° C. The focus on solid to liquid phase transition rather than a liquid to gas phase transition is important for thermal energy storage medium 136 with a high volumetric energy density, which is important to keep the overall volume of thermochemical system 100 low.

Additionally, the material for thermal energy storage medium 136 should have a relatively high boiling point so that it does not evaporate over time at high temperatures. While many materials could fit this description, an exemplary list of eligible materials is: silicon (Si), germanium (Ge), iron (Fe), steel, manganese (Mn), cobalt (Co), chromium (Cr), nickel (Ni), silver (Ag), copper (Cu), titanium (Ti), calcium (Ca), Fe/Si alloys, Fe/Ti alloys, iron silicates, cast iron, iron oxide (FeO), copper oxide (CuO), sodium metasilicate (Na₂SiO₃), sodium fluoride (NaF), potassium fluoride (KF), lithium fluoride (LiF), calcium fluoride (CaF₂), thorium fluoride (ThF₄), potassium carbonate (K₂CO₃), lead oxide (PbO), sodium carbonate (Na₂(CO₂)₃), sodium chloride (NaCl), calcium chloride (CaCl₂)), potassium chloride (KCl), barium chloride (BaCl₂), nickel chloride (NiCl₂), magnesium chloride (MgCl₂), calcium bromide (CaBr₂), potassium iodide (KI) or a mixture of these materials. One skilled in the art will recognize that any material with a phase transition between the desired temperature range for pyrolysis of preferably 700° C. to 2,000° C. can be used as a suitable thermal energy storage medium 136 in the present invention. It is desirable for the material to be relatively inexpensive and abundant. Thus, when operating in an inert or reducing environment, the most attractive candidates for latent heat energy storage are calcium fluoride, iron, steel, sodium metasilicate, nickel chloride, sodium fluoride, potassium carbonate, sodium carbonate, sodium chloride, calcium chloride, potassium chloride, magnesium chloride, potassium iodide, silicon, titanium, Fe/Si alloys, Fe/Ti alloys, manganese, and copper.

Another important consideration for the choice of material for thermal energy storage medium 136 that uses the latent heat storage process of thermal energy 150 is that the material should be able to be contained in molten state or liquid phase 136B without reacting or decomposing its container or vessel of containment material 134.

Thus, containment material 134 is selected from high temperature materials including nickel-based alloys, refractory metals, and refractory materials based on alumina (Al₃O₃), zirconia (ZrO₂), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, calcium oxide (CaO) and carbon such as graphite. These materials are advantageous as containment material 134 for thermal energy storage medium 136 as they are commonly used to contain molten salts and metals. However, there is a challenge regarding their stability over longer timescales of months and years that are desirable for the long-term operation of hydrocarbon decomposition reactor 106.

An Ellingham diagram is a useful tool to fine-tune the chemical compatibility of liquid phase 136A of the salt or metal chosen as thermal energy storage medium 136 and containment material 134 of which its container or vessel is made. An Ellingham diagram is a graphical representation of the Gibbs free energy change (ΔG) for a particular chemical reaction as a function of temperature. It is commonly used in metallurgy and materials science to predict the relative stability of different metal oxides at high temperatures. The diagram can also be used to determine the feasibility of a given reduction process, as it indicates the minimum temperature required to reduce a given metal oxide to its corresponding metal. In general, the lower the ΔG° f value for a metal oxide or sulfide, the more stable the compound is at a given temperature. By comparing the ΔG° f values for different metal oxides and sulfides at a given temperature, one can determine which compound is most stable under those conditions.

Step 210B involves choosing the material for thermal energy storage medium 136 that is stable in an oxidizing environment. It is separated from hydrocarbon pyrolysis reactor 106 gas environment which remains sealed in an inert or reducing environment within a hydrocarbon reaction vessel (not shown). Note that it is possible that hydrocarbon pyrolysis reactor 106 is actually made of a material which is stable to oxidation, thus simplifying the separation of the pyrolysis gas environment from the gas environment of thermal energy storage medium 136. In cases where the thermal energy storage material 136 must be contained in an oxidizing environment, it transfers released heat 154 to hydrocarbon pyrolysis reactor 106 that is sealed.

It is a high temperature sealing challenge to prevent air, oxygen, and water ingress into thermochemical system 100, and this challenge increases as temperature rises. Between 800° C. and 1,200° C., metals and specifically nickel-based alloys can withstand the high temperatures. Sealing is still a challenge, but certain metal and vermiculite seals can be used. Above 1,200° C., the only materials stable in an oxidizing environment are refractory ceramics and metal carbides—both of which are generally challenging to seal. To solve this sealing challenge, the sealing surfaces should be actively cooled below 1,200° C., and potentially below 400° C.

Of course, thermal energy 150 is also stored in thermal energy storage medium 136 by the sensible heat storage process according to Eq. 1. In principle, the temperature of any material can be heated up to store thermal energy 150 by the sensible heat storage process and cooled down to recover energy as released heat 154. The present teachings are specifically focused on materials which can deliver released heat 154 at temperatures over 700° C., but to get a sufficient temperature difference, the material should be stable above 800° C. All of the materials listed above as candidates for latent heat energy storage process can be heated up below and above their melting point temperature T_{Mp} to store thermal energy 154 by sensible heat storage process. Indeed, the above listed materials are all excellent candidates for thermal energy storage medium 136 that stores thermal energy 150 as sensible heat. For the highest temperature operation, it is containment materials 134 listed above (high temperature metals, graphite or solid carbon, metal oxides, metal carbides, metal nitrides and ceramic refractories) which are among the most attractive candidates for such choice of thermal energy storage medium 136.

Specifically, in step 210A for choices available given an inert, reducing or vacuum environment above 800° C. are nickel-based alloys, refractory metals, graphite or solid carbon, calcium fluoride, sodium metasilicate, nickel chloride, sodium fluoride, silica, alumina, magnesia, iron, and steel, or combinations thereof are the most suitable as thermal energy storage medium 136. For a material to be able to store a lot of thermal energy 150 by the sensible heat storage process per unit of mass, it should be able to operate over a large range of temperatures because the amount of thermal energy 150 stored is linearly proportional to the difference in temperature from storage or charge to discharge.

In a preferred embodiment, given inert, reducing or vacuum environment graphite or carbon is used as thermal energy storage medium 136 for storing thermal energy 150 by the sensible heat storage process because it is stable up to 2,200° C. in an inert environment maintained in nitrogen or vacuum environment and up to 3,000° C. in an inert environment maintained by argon or by helium. This enables a 800° C. to 2,200° C. temperature difference between high temperature T_{H} and low temperature T_{L} for providing released heat 154 for decomposition of hydrocarbon feedstock 108.

Additionally, in some embodiments graphite or carbon insulation materials are used as containment material 134 to contain the graphite or carbon thermal energy storage medium 136. Note that the energy density of graphite sensible heat storage process overtakes other materials capacity for latent heat storage process when operating over a temperature differential greater than ˜500° C. Operating at 2,000° C. will increase thermal loss from insulated volume 102 through insulated container 104. In this case, the thicknesses of top cover 104A, side wall 104B and bottom plate 104C need to be thicker, including up to a few meters. In another embodiment, alumina is used as thermal energy storage medium 136 that stores thermal energy 150 as sensible heat between 800° C. and 1,900° C. in inert, reducing or vacuum environments.

In contrast, for step 210B given an oxidizing environment and temperature above 800° C. the choice of materials for thermal energy storage medium 136 that store thermal energy 150 by the sensible heat storage process differs. Specifically, the preferred choice of material is nickel-based alloys, Al₂O₃, SiO₂, CaF₂, Na₂SiO₃, NiCl₂, NaF, Cu₂O, CuO, and FeO, or a combination thereof as described in the latent heat section above. Using the sensible heat storage process with a high heat capacity in an oxidizing environment is challenging because there are not many materials which are stable at high temperatures in an oxidizing environment. Nickel-based alloys, Al₂O₃, SiO₂, CaF₂, Na₂SiO₃, NiCl₂, NaF, Cu₂O, CuO, and FeO can be used in an oxidizing environment with the limitation on storage being containment material 134. In some embodiments, Al₂O₃ based refractories are used as a high temperature containment material 134 in an oxidizing environment, the temperature limit is approximately 1,900° C. before the Al₂O₃ refractory will melt.

Step 212 ensures thermal coupling between hydrocarbon pyrolysis reactor 106 and thermal energy storage medium 136. Thermal coupling can be achieved by different thermal or heat transfer mechanisms. In particular, released heat 154 that is discharged to hydrocarbon pyrolysis reactor 106 can be thermally coupled through at least one heat transfer mechanism that includes radiation, convection and conduction or a combination thereof.

Briefly, conduction is the transfer of heat through a solid material without the physical movement of the material itself. Convection is the transfer of heat through a fluid (liquid or gas) by the actual movement of the fluid. Radiation is the transfer of heat in the form of electromagnetic waves, primarily in the infrared and visible spectrum. In practice, all three heat transfer mechanisms will be present to varying degrees, with radiation and conduction likely to dominate in temperature regimes of 800° C. to 2,200° C. or at pyrolyzing temperatures at which hydrocarbon feedstock 108 undergoes pyrolysis.

More concretely, thermal coupling by thermal conduction requires a solid material to connect thermal energy storage medium 136 and hydrocarbon pyrolysis reactor 106 or hydrocarbon reaction vessel (when thermal energy storage medium 136 operates in an oxidizing environment). Alternatively, thermal energy storage medium 136 can contact the gas of hydrocarbon feedstock 108 directly (when operating in an inert or reducing environment). In embodiments relying on the latent heat storage process in oxidizing environments, containment material 134 of the thermal energy storage medium 136 is in contact with the hydrocarbon reaction vessel that holds hydrocarbon pyrolysis reactor 106. In embodiments relying on the sensible heat storage process in oxidizing environment, thermal energy storage medium 136 is positioned proximate to hydrocarbon pyrolysis reactor 106 held in the hydrocarbon reaction vessel. In particular, the hydrocarbon reaction vessel is positioned such that it physically rests upon, beside, or underneath thermal energy storage medium 136. In embodiments relying on latent heat storage process or sensible heat storage process in inert, reducing or vacuum environments thermal energy storage medium 136 can make up the hydrocarbon reaction vessel that holds hydrocarbon pyrolysis reactor 106 or it can be located within the hydrocarbon reaction vessel. It should be noted that any orientation could be suitable as long as it enables physical contact between thermal energy storage medium 136 and the hydrocarbon reaction vessel.

Thermal coupling by convective heat transfer requires that thermal energy storage medium 136 is coupled to the hydrocarbon reaction vessel via a fluid or gas or is a fluid that contacts hydrocarbon feedstock 108 directly. Thus, in some embodiments, thermal energy storage medium 136 is a molten metal or salt through which hydrocarbon feedstock 108 is injected, thus transferring thermal energy 150 through contact between the molten fluid and the gas of hydrocarbon feedstock 108. In some embodiments, hydrocarbon reaction vessel that holds hydrocarbon pyrolysis reactor 106 sits above thermal energy storage medium 136 within a gaseous or liquid medium, and convective currents in the gaseous or liquid medium driven by a temperature gradient between the hydrocarbon reaction vessel and thermal energy storage medium 136 drive heat transfer between the two thus providing for the requisite thermal coupling. In some embodiments, thermal energy storage medium 136 is itself a molten salt or metal and hydrocarbon reaction vessel is located within the molten salt or metal. In some embodiments, thermal energy storage medium 136 is a molten salt or metal contained within the pyrolysis reaction vessel. In still other embodiments a heat transfer fluid, either liquid or gas, is circulated between heat transfer storage medium 136 and the pyrolysis reaction vessel.

Thermal coupling by radiative heat transfer requires that thermal energy storage medium 136 is optically coupled to either the pyrolysis reaction vessel or a material within hydrocarbon feedstock 118 that can absorb electromagnetic energy. In some embodiments, the thermal energy storage medium 136 is positioned below, above, or to the side of the pyrolysis reaction vessel such that thermal radiation is transferred between the two. In still other embodiments, hydrocarbon feedstock 108 contains carbon particulates that absorb thermal radiation from thermal energy storage medium 136.

In the present exemplary embodiment, thermal energy storage medium 136 is thermally coupled through radiative heat transfer enabled when shutter mechanism 138 is open. Additionally, since the apertures of bottom and top shutter plates 140, 142 can be aligned to varying degrees the amount of radiative heat transfer can be adjusted. This means that the rate of delivery of released heat 154 to hydrocarbon pyrolysis reactor 106 can be controlled in the present embodiment.

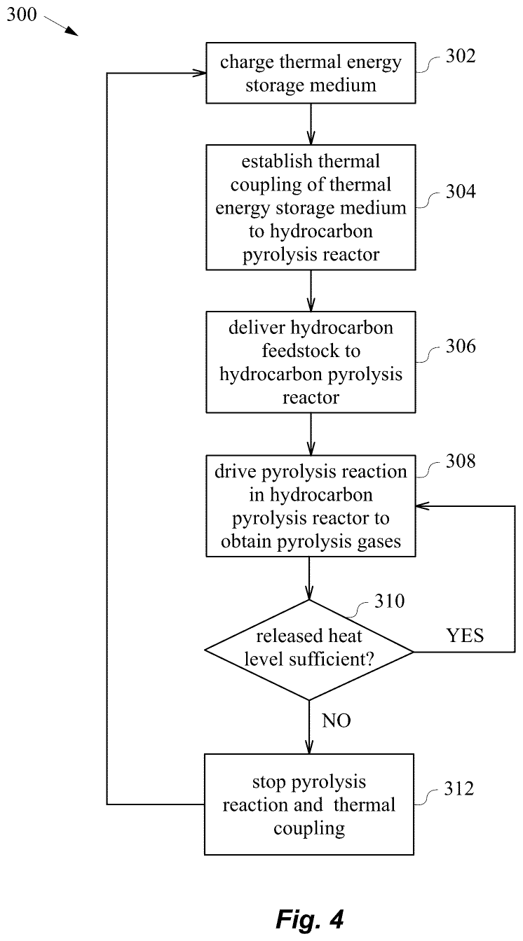

FIG. 4 is an operation flow diagram 300 that illustrates the details of operating thermochemical system 100 with reference to elements illustrated in FIGS. 1A-C and the graphs shown in FIGS. 2A-B. The details of operation include charging and discharging of thermal energy storage medium 136 in the present exemplary embodiment and in alternative embodiments addressed in the teachings related to setup flow diagram 200.

In step 302 heater 132 is turned on to start transferring thermal energy 150 to thermal energy storage medium 136. This commences the charging or heating period shown in FIG. 2A. The charging period starts at charge commence time tₒₒ when thermal energy storage medium 136 is at low temperature T_{L}. Charging continues until charge termination time t_{tc} when thermal energy storage medium 136 has reached high temperature T_{H}. At this point heater 132 is turned off.

In step 304 thermal coupling between charged thermal energy storage medium 136 and hydrocarbon pyrolysis reactor 106 is enabled. This coincides with discharge commence time t_{dc} when thermal energy storage medium 136 is at high temperature T_{H}, as shown in FIG. 2B. Discharge occurs once shutter mechanism 138 is opened to permit thermal coupling via radiative heat transfer through alignment of apertures of bottom and top shutter plates 140, 142. As a result, released heat 154 is transferred from thermal energy storage medium 136 to hydrocarbon pyrolysis reactor 106 at a rate dictated by the level of alignment between the apertures of bottom and top shutter plates 140, 142

In step 306 hydrocarbon feedstock 108 is delivered to hydrocarbon pyrolysis reactor 106. Since at this point hydrocarbon pyrolysis reactor 106 is receiving requisite released heat 154 from thermal energy storage medium 136 the operation can proceed to the next step.

During step 308 hydrocarbon pyrolysis reactor 106 pyrolyzes or performs pyrolysis of hydrocarbon feedstock 108 at temperatures between 700° C. and 2,000° C. Such thermochemical decomposition of hydrocarbon feedstock 108 is also known as pyrolyzation, cracking or direct decomposition. As a result, top outlet 118 releases flow 122 of pyrolysis products 124 through outlet pipe 120. Flow 122 essentially includes solid carbon product 128, hydrocarbon fraction 130 and pyrolysis-derived hydrogen 126.

Step 308 of pyrolyzing hydrocarbon feedstock 108 can proceed in the presence of a catalyst. If step 308 is catalytic, then the pyrolysis can take place at pyrolyzation temperatures as low as 400° C., although preferably above 700° C. Typically, with catalytic pyrolysis the decomposition of hydrocarbon feedstock 108 occurs on the surface of a catalyst particle and solid carbon product 128 adheres to the surface of such catalyst particle. When such adhesion takes place, it can lead to deactivation of the catalyst and/or loss of the catalyst. If used in step 308, the catalyst should contain one of the transition metals such as Cobalt (Co), Ruthenium (Ru), Nickel (Ni), Rhenium (Re), Platinum (Pt), Copper (Cu), Tungsten (W), Iron (Fe) and Molybdenum (Mo) or compounds thereof. In embodiments where industrial application of pyrolysis-derived hydrogen 126 and solid carbon product 128 produced in pyrolysis step 308 is iron and steelmaking, the catalyst can contain common steel alloying elements such as Manganese (Mn), Nickel (Ni), Chromium (Cr), Carbon (C) and Vanadium (V) as these are typically added in subsequent steelmaking to produce different grades of steel.

When step 308 involves non-catalytic pyrolysis, pyrolyzation temperatures in excess of 1,100° C. are typically required to achieve higher yields of hydrocarbon feedstock 108 to solid carbon product 128 and hydrogen 126. Further information about thermochemical decomposition parameters of hydrocarbons suitable for use as hydrocarbon feedstock 108 is available in the literature. The reader is here referred to M. Wullenkrod, “Determination of Kinetic Parameters of the Thermal Dissociation of Methane”, Ph.D. Dissertation, Lehrstuhl fur Solartechnik (DLR), RWTH Aachen University, 2012 as well as S. Rodat et al., “Kinetic modelling of methane decomposition in tubular solar reactor”, Chemical Engineering Journal, 146 (2009), pp. 120-127.

While step 308 is proceeding a periodic or continuous verification step 310 is performed to determine the state of charge of thermal energy storage medium 136. This is done to determine how much yet to be released heat 154 is available to drive pyrolysis in step 308.

Note that pyrolyzation temperature for the pyrolysis reaction needs to be maintained above a desired temperature such as 700° C. In light of this the primary benefit of the heat storage process via latent heat over the heat storage process via sensible heat becomes clear. It is that latent heat is stored and released at a relatively constant temperature, namely at melting point temperature T_{Mp}, as seen in FIGS. 2A-B. This occurs because the temperature of the material making up thermal energy storage medium 136 stays roughly constant when it is going through a phase transition, such as between liquid phase 136B and solid phase 136A, as is the case in the present invention.

In some embodiments, it is desirable for the pyrolysis reaction to be driven at constant pyrolyzation temperature in order to control the reaction yield. To maintain a constant temperature, the heat flux of released heat 154 into hydrocarbon pyrolysis reactor 106 must be controlled. This is done in the present exemplary embodiment by controlling the rate through alignment between the apertures of bottom and top shutter plates 140, 142 of shutter mechanism 138. It should further be noted that thermal coupling via radiative, convective, and conductive heat fluxes are all dependent on temperature differences between two mediums. Thus, the constant temperature of thermal energy storage medium 136 releasing its latent heat as released heat 154 during a phase transition from liquid phase 136B to solid phase 136A provides the desirable constant heat flux. Conversely, since sensible heat is released as thermal energy storage medium 136 is cooling down, the heat flux will be continuously decreasing. This decrease can be adjusted for by increasing the alignment between the apertures bottom and top shutter plates 140, 142. However, in many cases it is not desirable to continue until thermal energy storage medium 136 is fully discharged and has reached its low temperature T_{L} as shown in FIG. 2B.

Verification step 310 takes into account the desired amount of heat flux that released heat 154 is providing to hydrocarbon pyrolysis reactor 106. While released heat 154 is sufficient to drive hydrocarbon pyrolysis at the desired pyrolyzation temperature to assure the desired reaction yield of pyrolysis products 124, namely solid carbon product 128 and hydrogen 126, then step 308 is allowed to continue. When released heat 154 is no longer sufficient to provide for pyrolysis at the desired pyrolyzation temperature then step 310 proceeds to step 312.

In step 312 pyrolysis reaction is stopped. Shutter mechanism 138 is closed and delivery of hydrocarbon feedstock 108 to hydrocarbon pyrolysis reactor 106 is turned off. Step 312 then returns the operation to step 302 of charging thermal energy storage medium 136. In other words, heater 132 is turned on again to start transferring thermal energy 150 to thermal energy storage medium 136. This recommences the charging or heating period shown in FIG. 2A, albeit thermal energy storage medium 136 may not yet have reached low temperature T_{L} at this time.

Although flow diagram 300 illustrates charging step 302 and driving pyrolysis step 308 as not being practiced at the same time, contemporaneous or temporally overlapping practice of these steps is desirable in many applications. Now, the heating or charging of thermal energy storage medium 136 takes place over a certain period of time. It is advantageous when a timing or temporal profile of the charging or heating is independent of or decoupled from the receiving of released heat 154 by hydrocarbon pyrolysis reactor 106 and hence decoupled from thermochemical decomposition of hydrocarbon feedstock 108 through pyrolysis. This is particularly important when the energy input into heater 132 is discontinuous, periodic or intermittent. Such cases arise when the energy input is provided by an intermittent energy source. Examples of suitable intermittent energy sources are wind turbines, solar photovoltaics, solar thermal generators, tidal energy generators and hydro-electric energy generators.

To achieve the decoupling, step 302 of charging of thermal energy storage medium 136 with thermal energy 150 can be practiced for at least some time that overlaps with driving the pyrolysis reaction in step 308 with released heat 154. This allows the present invention to overcome the present challenges of producing and delivering hydrogen 126 continuously via hydrocarbon pyrolysis for use in industrial applications while relying on intermittent energy sources to drive the pyrolysis reaction. More specifically, such decoupling of steps 302 and 308 enables the delivery of pyrolysis products 124 that include hydrogen 126 and solid carbon product 124 that may be solid carbon from the pyrolysis of hydrocarbon feedstock 108 while overcoming the challenges associated with requiring the same temporal profile for heat input and pyrolysis outputs.

In embodiments where steps 302 and 308 are decoupled it is important that thermal energy storage medium 136 be able to store a large amount of thermal energy 150. Thermal energy storage medium 136 should preferably be able to contain thermal energy 150 in sufficient amount to maintain the hydrocarbon pyrolysis reaction in hydrocarbon pyrolysis reactor 106 through discharge of released heat 154 for at least 1 hour and preferably for longer than 2 hours without needing to be recharged. More preferably still, the discharge of released heat 154 should be sustainable for over 4 or even 8 hours without the need for any additional thermal energy 150 to be input. With certain intermittent sources the period over which sufficient released heat 154 is so long that thermal energy storage medium 136 needs to have a still larger thermal mass. These cases occur when pyrolysis needs to be driven for periods of time extending to over 12 hours, and even over 24 hours without additional energy input into thermochemical system 100.

It will be understood by one skilled in the art that the temperature of the hydrocarbon pyrolysis reactor 106 must be maintained above a specific temperature during this extended time period. For pyrolysis of hydrocarbon stock 108 such as methane or natural gas in the absence of a catalyst this is above 1,000° C. or more preferably above 1,100° C. and for methane or natural gas pyrolysis in the presence of a catalyst this is above 400° C. or more preferably above 700° C.

The temperature at which hydrocarbon pyrolysis reactor 106 must be maintained will be different for different hydrocarbon feedstocks 108, reactor types, and exact thermochemical processes. It will also be understood by one skilled in the art that the quantity or amount of thermal energy storage medium 136, both by volume and mass, can be tuned or designed for a specific time period of thermal energy storage to maintain the hydrocarbon pyrolysis reaction. Thermal energy storage medium 136 can be charged to different amounts or charge levels. The charge level is determined by the mass or volume of thermal energy storage medium 136 that is in liquid phase 136B or evaporated to store a specific amount of latent heat and/or as determined by the temperature to which thermal energy storage medium 136 is heated to store a specific amount of sensible heat. Thermal energy storage medium 136 can also be discharged to different amounts of discharge levels. This is accomplished by controlling the mass or volume of thermal energy storage medium 136 that is allowed to cool, by controlling shutter mechanism 138 via aperture alignment between thermal energy storage medium 136 and hydrocarbon pyrolysis reactor 106, or by controlling the minimum temperature to which thermal energy storage medium 136 is allowed to drop or cool to.

Furthermore, thermal energy storage medium 136 can be charged and discharged at different rates, where the rate is defined by the change in the amount of thermal energy storage divided by the maximum available thermal energy storage in thermal energy storage medium 136. This is accomplished by controlling variables such as the temperature difference between hydrocarbon pyrolysis reactor 106 and thermal energy storage medium 136, the aperture alignment of shutter mechanism 138 between thermal energy storage medium 136 and hydrocarbon pyrolysis reactor 136, and/or by inflow 114 of hydrocarbon feedstock 108 delivered to or actually passing through hydrocarbon pyrolysis reactor 106. It will also be understood by one skilled in the art that the pyrolyzation temperature maintained will impact the necessary heat transfer or thermal energy transfer and therefore the length of time over which thermal energy storage medium 136 can be discharged.

In a preferred embodiment, the amount of thermal energy storage medium 136 and the length of time for which it is designed to maintain the hydrocarbon pyrolysis reaction are designed to match the energy input to hydrocarbon pyrolysis reactor 106 and thermal energy storage medium 136. For example, if entire thermochemical system 100 is to be run off only solar energy and it is located at the equator, which receives approximately 12 hours of daylight every day, thermal energy storage medium 136 is designed to store enough thermal energy 150 to run the hydrocarbon pyrolysis reactor 106 for a minimum of 12 hours during the night. Preferably, hydrocarbon pyrolysis reactor 106 operation is tuned to increase or decrease the rate of reaction of hydrocarbon feedstock 108 or the throughput of hydrocarbon feedstock 108 to increase or decrease the discharge rate of thermal energy storage medium 136 in order to extend the amount of thermal energy storage time. Preferably, the cost of the thermal energy storage medium 136, which will typically be determined by its volume or mass, will be minimized to meet the minimum duration of thermal energy storage time that is required for each installation location and energy source used by thermochemical system 100.

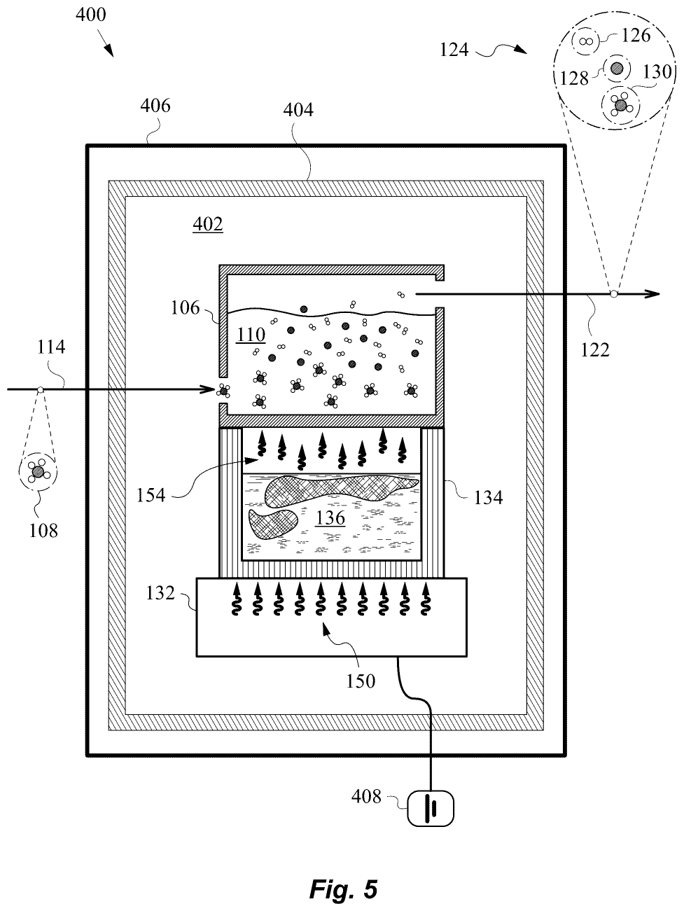

FIG. 5 is a plan schematic view of another thermochemical system 400 according to the invention in which an insulated zone or insulated volume 402 enclosed by an insulation container 404 is placed within a larger reaction vessel 406. Analogous parts and elements in this embodiment are called out with previously used reference numerals for clarity.

As in the previous embodiment, insulated volume 402 contains hydrocarbon pyrolysis reactor 106 that uses molten salt or metal 110 for pyrolysis of hydrocarbon feedstock 108 that is delivered to it as inflow 114. Pyrolysis reactor 106 is thermally coupled with thermal energy storage medium 136 contained in the vessel of containment material 134 and also located within insulated volume 402. The thermal coupling allows hydrocarbon pyrolysis reactor 106 to receive released heat 154 from thermal energy storage medium 136.

Insulated volume further contains heater 132 connected to an energy source 408, which can be an intermittent source as described above. Thermal energy storage medium 136 is positioned to be in thermal communication with heater 132 and to receive from it thermal energy 150. As in the prior embodiment, thermal energy 150 is used to charge thermal energy storage medium 136 so that it can provide released heat 154 to hydrocarbon pyrolysis reactor 106 while being discharged. In turn, hydrocarbon pyrolysis reactor 106 releases flow 122 of pyrolysis products 124 that include pyrolysis-derived hydrogen 126 and pyrolysis-derived solid carbon product 128 as well as a hydrocarbon fraction 130.

Reaction vessel 406 supports a controlled environment such as an inert, reducing, vacuum or oxidizing environment. Furthermore, reaction vessel 406 can be a pressure vessel to enable hydrocarbon pyrolysis reactor 106 to operate at elevated pressures up to 300 bar. When pumped down, reaction vessel 406 defines a vacuum chamber, thus enabling pyrolysis reactor 106 to operate in a vacuum environment or in achieving a desired controlled gas environment/atmosphere within reaction vessel 406. Specifically, reaction vessel 406 can be first evacuated and then refilled with the desired atmosphere such as inert or reducing atmosphere.

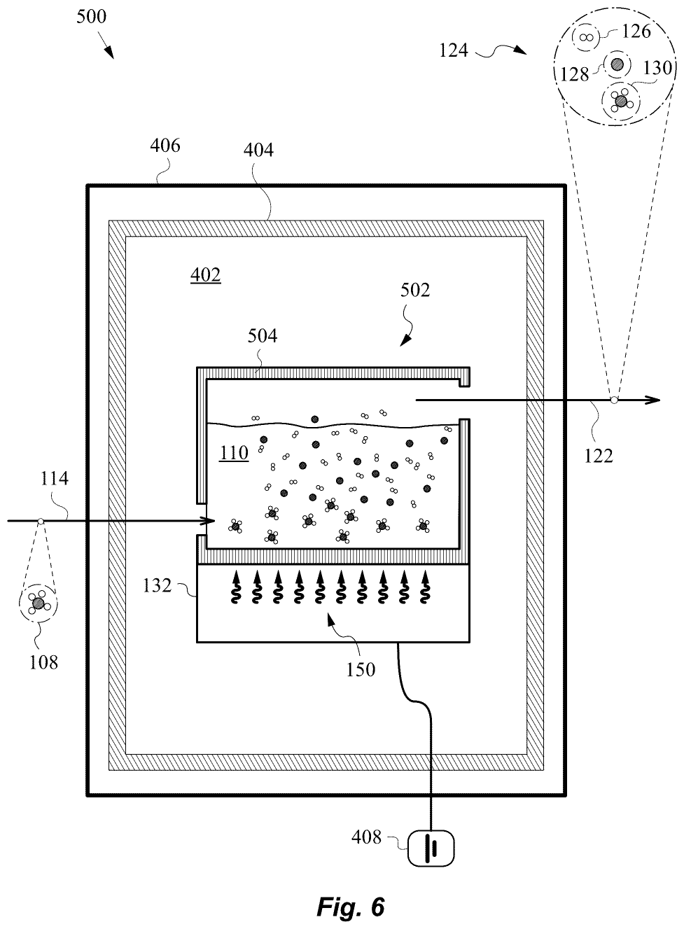

FIG. 6 is a plan schematic view of another thermochemical system 500 that also uses reaction vessel 406 to enclose insulation container 404 that defines insulated zone or insulated volume 402. Once again, analogous parts and elements in this embodiment are called out with previously used reference numerals for clarity.

As in thermochemical system 400, in thermochemical system 500 insulated volume 402 has heater 132 for providing thermal energy 150 to be stored. However, in contrast with thermochemical system 400, thermochemical system 500 deploys a hydrocarbon pyrolysis reactor 502 that is made of a thermal energy storage medium 504. Thus, thermal energy 150 from heater 132 is directly delivered to thermal energy storage medium 504 whenever heater 132 is turned on.

Because hydrocarbon pyrolysis reactor 502 is effectively integrated with thermal energy storage medium 504 in this embodiment, the transfer of released heat 154 between thermal energy storage medium 502 and hydrocarbon pyrolysis reactor 504 and specifically its internal reaction zone in molten salt or metal 110 can use thermal coupling via radiative, convective, and conductive heat fluxes. Thermal energy 150 stored in the thermal energy storage medium 504 can be based on heat storage processes that include latent or sensible heat. One skilled in the art will understand that temperature limits must be enabled to prevent degradation of the reactor material itself or thermal energy storage material itself.

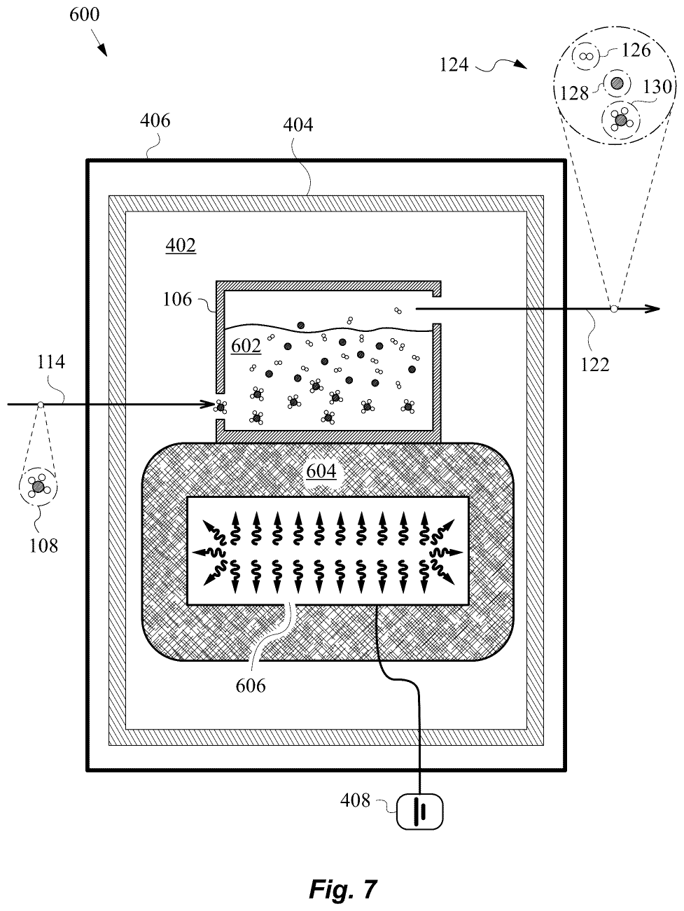

FIG. 7 is a plan schematic view of still another thermochemical system 600 that also uses reaction vessel 406 to enclose insulation container 404 that defines insulated zone or insulated volume 402. Once again, analogous parts and elements in this embodiment are called out with previously used reference numerals for clarity.

In thermochemical system 600 a thermal energy storage medium 602 is a molten metal or molten salt that is inside hydrocarbon pyrolysis reactor 106 and into which inflow 114 of hydrocarbon feedstock 108 is injected.

In other words, in this case thermal coupling between thermal energy storage medium 602 and hydrocarbon pyrolysis reactor 106 is ensured by virtue of the latter including or containing thermal energy storage medium 602. Such thermal coupling is very effective as it provides for transferring released heat 154 through contact between the molten metal or salt that constitutes thermal energy storage medium 602 and hydrocarbon feedstock 108.

In the present embodiment, the sensible energy storage process is based on an increase in temperature of molten metal or salt 602 into which hydrocarbon feedstock 108 is being injected. The reaction temperature at which pyrolysis of hydrocarbon feedstock 108 is performed is then varied in accordance with the temperature of molten metal or salt 602. In fact, in some embodiments hydrocarbon pyrolysis reactor 106 itself can be located within molten metal or salt 602 that serves as the thermal energy storage medium.

In addition, a second thermal energy storage medium 604 surrounds a heater 606 is deployed in this embodiment. This enables a direct transfer of thermal energy 150 to thermal energy storage medium 604 with minimal losses in thermal energy 150 that heater 606 generates. As suggested by the present embodiment, some or all of the thermal energy storage media and heat transfer mechanisms or systems can be combined. They may also be controlled together or separately.

A person skilled in the art will recognize that still other variants of the above embodiments are possible. In particular, when the thermal energy storage medium is positioned proximate to the hydrocarbon pyrolysis reactor in such a manner that the thermal coupling supports heat transfer by radiation between the thermal energy storage medium and the hydrocarbon pyrolysis reactor other shutter mechanisms than apertured plates can be used. For example, a control mechanism can be used to adjust the area receiving radiation from the high temperature thermal energy storage medium that includes lenses to control the radiative heat flux to the pyrolysis reaction vessel or to hydrocarbon pyrolysis reactor. However, whether the control mechanism includes shutters, apertures, or lenses it must be fabricated from a material that can withstand the high temperatures within the insulation volume containing the thermal energy storage medium and the pyrolysis reaction vessel.

In fact, there are many suitable control mechanisms to control the heat flux coming from the thermal energy storage medium into the pyrolysis reaction vessel. Control mechanisms that rely on conduction are very difficult. It is hard to variably control conduction as it requires two materials to be in contact. Thus, in some embodiments the control mechanism controls the convective heat flux by controlling the flow rate of a heat transfer fluid between the thermal energy storage medium and the pyrolysis reaction vessel. However, radiative heat flux generally dominates at temperatures above 1,000° C. due to its dependence on temperature to the fourth power (T\hat{ }4).

A major benefit of the hydrocarbon pyrolysis reaction with the goal of producing hydrogen and solid carbon is that it is desirable to take the reaction to completion and increasing temperature and increasing residence time at high temperature increases the pyrolysis yield. This is not true of a large number of industrial chemical processes such as ammonia production, the Fischer-Tropsch reaction, or even a hydrocarbon decomposition process such as ethylene cracking. In each of these reactions, the temperature range or reaction time needs to be carefully controlled. The Haber-Bosch process is used industrially to make ammonia where nitrogen and hydrogen gas are reacted over a catalyst at high pressures to form ammonia. At low temperatures (around 350° C.) the ammonia synthesis reaction proceeds slowly, but the ammonia yield can be high because the reverse reaction is suppressed. However, at higher temperatures (around 550° C.), the reaction rate increases significantly, but the equilibrium position shifts back toward the reactants (N₂ and H₂), resulting in a lower ammonia yield. Thus, a tightly controlled reaction temperature is critical. Temperature similarly affects the reaction rate and yield of the Fischer-Tropsch reaction where higher temperature favors higher reaction rate, but too high of temperature favors the reverse reaction. Hydrocarbon cracking to form ethylene is another highly sensitive process where the residence time and temperature of the reaction must be carefully controlled or the ethylene yield will suffer significantly.

In contrast, when hydrogen and carbon are the desired hydrocarbon decomposition products, increasing temperature and residence time only increases the reaction rate and yield. Thus, in some embodiments, the temperature of the hydrocarbon pyrolysis reaction is varied in accordance with the temperature of the sensible heat thermal energy storage medium. For non-catalytic driven pyrolysis, when the temperature is above about 1,200° C. and the residence time is >1 seconds, the reaction yield will be above 80%. Higher temperatures will increase the reaction yield. In still other embodiments, the temperature of the reaction is varied between 700° C. and up to 2,000° C. in order to leverage the temperature of the thermal energy storage medium without the usage of an additional mechanism such as a shutter or aperture to control heat flux. Over this temperature range, the reaction yield will vary between about 90% to 99.5% or even higher if a catalyst is present. In still other embodiments, the sensible heat thermal energy storage medium is the pyrolysis reaction vessel and the reaction temperature is varied in accordance with the temperature of the energy storage medium. In yet another embodiment, the sensible heat thermal energy storage medium is the molten metal or salt into which the hydrocarbon feedstock is injected such that the reaction temperature is varied in accordance with the temperature of the energy storage medium. In another embodiment still, both the reaction temperature is varied and a mechanism is employed to control the heat flux into the pyrolysis reaction vessel.

In the present invention, the thermal energy storage medium is heated via electrical energy or the chemical energy of combustion. The thermal energy storage medium could be heated externally or internally via electrical power flowing through resistive heating elements made of materials such as silicon carbide, molybdenum disilicide, nichrome, graphite, carbon fiber composite, tungsten, tantalum, or iron-chromium-aluminum alloys. Induction heating can also be used wherein a high-frequency alternating current (AC) power source is used to generate an alternating magnetic field within a coil or induction heating coil.

When an electrically conductive material is placed within the coil, it becomes part of an electrical circuit. The alternating magnetic field induces eddy currents (circular electrical currents) to flow within the material. These eddy currents generate resistive heating due to electrical resistance in the material. In other words, the material heats up as it resists the flow of the induced currents. Induction heating could be coupled to any of the electrically conductive thermal energy storage materials listed above such as chromium, titanium, iron, carbon steel, cobalt, nickel, silicon, manganese, cast iron, copper, germanium, graphite, carbon, calcium, and alloys thereof. A plasma generated by a microwave, electric discharge voltage, or laser could also be used to heat the thermal energy storage medium. Finally, in an embodiment, the thermal energy storage medium is heat via the chemical energy resulting from combustion of a material such as a hydrocarbon, hydrogen, or a metal.

It will be recognized by one skilled in the art that multiple heating methods could be used in the same thermochemical system and that different heating methods could be used to heat the thermal energy storage medium and the hydrocarbon pyrolysis reactor. For example, an induction heating system or heater can be used to heat the thermal energy storage medium and a combustion heating system or heater to partially heat the hydrocarbon pyrolysis reactor.

In many of the above embodiments it is further preferred that a fraction of the solid carbon product be fluidized out of the hydrocarbon pyrolysis reactor by the pyrolysis products. Fortunately, operating at the high temperatures according to the invention is conducive to fluidizing solid carbon out of the hydrocarbon pyrolysis reactor. Further, it is preferable that when using methane as the hydrocarbon feedstock the hydrocarbon pyrolysis reactor be set to maintain a methane to hydrogen reaction yield of greater than 70% and that the solid carbon product actually be solid carbon.

In some cases where the hydrocarbon pyrolysis reactor is contained in the hydrocarbon reaction vessel the latter can be positioned above or on top the thermal energy storage medium and thus the heat transfer is driven by convective currents due to a temperature gradient between the hydrocarbon reaction vessel and the thermal energy storage medium. Of course, this heat transfer includes the transfer of the released heat. In other cases, the hydrocarbon reaction vessel is thermally coupled with the thermal energy storage medium by a heat transfer fluid. Suitable heat transfer fluid can be a liquid or a gas that can be circulated between the thermal energy storage medium and the pyrolysis reaction vessel to drive heat transfer including transfer of the released heat. A mechanism for adjusting the flow rate of the heat transfer fluid is also provided in some embodiments. In still other cases, the hydrocarbon reaction vessel is thermally coupled with the thermal energy storage medium with a mechanism for adjusting an area receiving a radiative heat flux from the thermal energy storage medium including the released heat. The mechanism can be selected from among shutters, apertures and lenses or combinations of these or derivatives of the exemplary mechanisms described above.

It will be evident to a person skilled in the art that the present invention admits of still other embodiments and variants. Therefore, its scope should be judged by the claims and their legal equivalents.

1. A thermochemical system for thermochemical decomposition of a hydrocarbon feedstock, said thermochemical system comprising:
a) an insulated volume enclosed by an insulation material;
b) a heater located within said insulated volume;
c) a thermal energy storage medium located within said insulated volume, said thermal energy storage medium positioned for thermal communication with said heater whereby said thermal energy storage medium is subject to heating by said heater and storing a thermal energy by a heat storage process, said thermal energy storage medium also being configured for releasing said thermal energy in the form of a released heat;
d) a hydrocarbon pyrolysis reactor within said insulated volume and thermally coupled with said thermal energy storage medium for receiving said released heat from said thermal energy storage medium;
wherein said hydrocarbon pyrolysis reactor uses said released heat for performing said thermochemical decomposition through pyrolysis of said hydrocarbon feedstock to produce pyrolysis products containing primarily hydrogen and a solid carbon product.

2. The thermochemical system of claim 1, wherein said hydrocarbon feedstock substantially comprises methane or natural gas and said solid carbon product comprises solid carbon.

3. The thermochemical system of claim 1, wherein said pyrolysis of said hydrocarbon feedstock is performed at a pyrolyzation temperature between 700° C. and 2,000° C.

4. The thermochemical system of claim 1, wherein a fraction of said solid carbon product is fluidized out of said hydrocarbon pyrolysis reactor by said pyrolysis products.

5. The thermochemical system of claim 1, wherein said hydrocarbon feedstock substantially comprises methane and said hydrocarbon pyrolysis reactor is set to maintain a methane to hydrogen reaction yield of greater than 70%.

6. The thermochemical system of claim 1, wherein a temporal profile of said heating by said heater of said thermal energy storage medium is decoupled from said receiving of said released heat from said thermal energy storage medium by said hydrocarbon pyrolysis reactor and from said thermochemical decomposition through pyrolysis.

7. The thermochemical system of claim 1, wherein an energy input into said heater is provided by an intermittent energy source selected from among wind turbines, solar photovoltaics, solar thermal generators, tidal energy generators and hydro-electric energy generators.

8. The thermochemical system of claim 1, wherein said heat storage process comprises a latent heat energy storage process through a solid to liquid phase transition of said thermal energy storage medium and said released heat is generated from a liquid to solid phase transition of said thermal energy storage medium.

9. The thermochemical system of claim 8, wherein said thermal energy storage medium comprises a material selected from among silicon (Si), germanium (Ge), iron (Fe), steel, manganese (Mn), cobalt (Co), chromium (Cr), nickel (Ni), silver (Ag), copper (Cu), titanium (Ti), calcium (Ca), Fe/Si alloys, Fe/Ti alloys, iron silicates, cast iron, iron oxide (FeO), copper oxide (CuO), sodium metasilicate (Na₂SiO₃), sodium fluoride (NaF), potassium fluoride (KF), lithium fluoride (LiF), calcium fluoride (CaF₂), thorium fluoride (ThF₄), potassium carbonate (K₂CO₃), lead oxide (PbO), sodium carbonate (Na₂(CO₂)₃), sodium chloride (NaCl), calcium chloride (CaCl₂)), potassium chloride (KCl), barium chloride (BaCl₂), nikel chloride (NiCl2), magnesium chloride (MgCl₂), calcium bromide (CaBr₂), potassium iodide (KI) or a mixture of said materials, and wherein said containment material supports said thermal energy storage medium in an environment selected from among an inert environment, an oxidizing environment, a reducing environment and a vacuum environment.

10. The thermochemical system of claim 8, wherein said hydrocarbon pyrolysis reactor is contained in a hydrocarbon reaction vessel and said containment material containing said thermal energy storage medium is in contact with said hydrocarbon reaction vessel.

11. The thermochemical system of claim 1, wherein said heat storage process comprises a sensible energy storage process based on an increase in temperature of said thermal energy storage medium while in a solid phase or while in a liquid phase and said released heat is generated from a decrease in temperature of said thermal energy storage medium.

12. The thermochemical system of claim 11, wherein said thermal energy storage medium comprises a material selected from among graphite, silica, alumina, magnesia, copper oxide (Cu₂O), iron oxide (FeO), silicon (Si), germanium (Ge), iron (Fe), steel, manganese (Mn), cobalt (Co), chromium (Cr), nickel (Ni), silver (Ag), copper (Cu), titanium (Ti), calcium (Ca), Fe/Si alloys, Fe/Ti alloys, iron silicates, cast iron, copper oxide (CuO), sodium metasilicate (Na₂SiO₃), sodium fluoride (NaF), potassium fluoride (KF), lithium fluoride (LiF), calcium fluoride (CaF₂), thorium fluoride (ThF₄), potassium carbonate (K₂CO₃), lead oxide (PbO), sodium carbonate (Na₂(CO₂)₃), sodium chloride (NaCl), calcium chloride (CaCl₂)), potassium chloride (KCl), barium chloride (BaCl₂), nickel chloride (NiCl₂), magnesium chloride (MgCl₂), calcium bromide (CaBr₂), potassium iodide (KI) or a mixture of said materials, and wherein said thermal energy storage medium is contained in an environment selected from among an inert environment, a reducing environment, an oxidizing environment and a vacuum environment.

13. The thermochemical system of claim 11, wherein said hydrocarbon pyrolysis reactor is contained in a hydrocarbon reaction vessel, said hydrocarbon reaction vessel being in physical proximity to said thermal energy storage medium, wherein said physical proximity includes positioning on top of said thermal energy storage medium, beside said thermal energy storage medium and underneath said thermal energy storage medium.

14. The thermochemical system of claim 11, wherein said thermal energy storage medium comprises a molten metal or salt and wherein said hydrocarbon pyrolysis reactor is thermally coupled with said thermal energy storage medium via injection of said hydrocarbon feedstock into said thermal energy storage medium thereby transferring said released heat through contact between said molten metal or salt and said hydrocarbon feedstock.

15. The thermochemical system of claim 11, wherein said thermal energy storage medium comprises a molten metal or salt and wherein said hydrocarbon pyrolysis reactor is located within said molten metal or salt.

16. The thermochemical system of claim 1, wherein said thermal energy storage medium is contained within a containment material selected from high temperature materials including nickel-based alloys, refractory metals based on alumina based on alumina (Al₂O₃), zirconia (ZrO₂), silica (SiO₂), magnesia (MgO), chromium oxide (Cr₂O₃), silicon carbide (SiC), tungsten carbide, boron carbide, silicon nitride, aluminum nitride, boron nitride, graphite, carbon-carbon composites, cordierite, mullite, spinel, chromite, calcium oxide (CaO) and carbon such as graphite.

17. The thermochemical system of claim 1, wherein said hydrocarbon pyrolysis reactor is thermally coupled with said thermal energy storage medium such that said released heat is discharged into said hydrocarbon pyrolysis reactor via at least one heat transfer mechanism selected from among radiation, convection and conduction.

18. The thermochemical system of claim 1, wherein said hydrocarbon pyrolysis reactor is contained in a hydrocarbon reaction vessel, and wherein said hydrocarbon reaction vessel is positioned above said thermal energy storage medium such that convective currents driven by a temperature gradient between said hydrocarbon reaction vessel and said thermal energy storage medium drive heat transfer between said hydrocarbon reaction vessel and said thermal energy storage medium including transfer of said released heat.

19. The thermochemical system of claim 1, wherein said hydrocarbon pyrolysis reactor is contained in a hydrocarbon reaction vessel and wherein said hydrocarbon reaction vessel is thermally coupled with said thermal energy storage medium by a heat transfer fluid comprising a liquid or a gas, said heat transfer fluid being circulated between said thermal energy storage medium and said pyrolysis reaction vessel to drive heat transfer between said hydrocarbon reaction vessel and said thermal energy storage medium including transfer of said released heat.

20. The thermochemical system of claim 1, wherein said hydrocarbon pyrolysis reactor is contained in a hydrocarbon reaction vessel and wherein said hydrocarbon reaction vessel is thermally coupled with said thermal energy storage medium with a mechanism for adjusting an area receiving a radiative heat flux from said thermal energy storage medium including said released heat, said mechanism being selected from among shutters, apertures and lenses.

21. The thermochemical system of claim 1, wherein said thermal energy storage medium is configured for releasing said released heat in a quantity sufficient to maintain said thermochemical decomposition through pyrolysis of said hydrocarbon feedstock for a time period greater than 1 hour without being subject to heating by said heater.

22. The thermochemical system of claim 21, wherein said time period is greater than 4 hours or greater than 12 hours.

23. A thermochemical process for thermochemical decomposition of a hydrocarbon feedstock, said thermochemical process comprising:
a) providing an insulated volume enclosed by an insulation material;
b) locating a heater within said insulated volume;
c) locating said thermal energy storage medium within said insulated volume, wherein said thermal energy storage medium is positioned for thermal communication with said heater whereby said thermal energy storage medium is subject to heating by said heater and storing a thermal energy by a heat storage process, said thermal energy storage medium also being configured for releasing said thermal energy in the form of a released heat;
d) providing a hydrocarbon pyrolysis reactor within said insulated volume and thermally coupling said hydrocarbon pyrolysis reactor with said thermal energy storage medium for receiving said released heat from said thermal storage medium;
whereby said hydrocarbon pyrolysis reactor uses said released heat for performing said thermochemical decomposition through pyrolysis of said hydrocarbon feedstock to produce pyrolysis products containing primarily hydrogen and a solid carbon product.
